(19) United States
(12) Patent Application Publication
(10) Pub. No.: US 2011/0079938 A1
(43) Pub. Date: Apr. 7, 2011

(54) COMPOSITE LEVEL TOOL

(76) Inventor: James S. Allemand, Mokena, IL (US)

(21) Appl. No.: 12/896,708

(22) Filed: Oct. 1, 2010

Related U.S. Application Data
(62) Division of application No. 12/122,461, filed on May 16, 2008, now abandoned.
(60) Provisional application No. 60/938,992, filed on May 18, 2007.

(51) Int. Cl. B29C 45/14

(52) U.S. Cl. 264/251

(57) ABSTRACT

A method of manufacturing a level tool is presented. The method includes providing a frame, providing a pair of plastic cover plates arranged on opposite sides of the frame, and forming at least one vial window in each cover plate by a dual plastic injection molding process, wherein the at least one vial window is made of a plastic material of a different color than the cover plate and is configured to receive and support at least a portion of a vial.

### RELATED APPLICATIONS

The present patent document is a divisional of application Ser. No. 12/122,461, filed May 16, 2008, which claims the benefit of the filing date under 35 U.S.C. §119(e) of Provisional U.S. Patent Application Ser. No. 60/938,992, filed May 18, 2007. All of the foregoing applications are hereby incorporated by reference.

### BACKGROUND OF THE INVENTION

The invention relates generally to a level tool for indicating the orientation of a workpiece. More specifically, the invention relates to a composite level tool having plastic body portions made using a dual plastic injection molding process.

As is known in the art, level tools are used to indicate the orientation of a workpiece, a surface or a structure with respect to a reference axis, such as a horizontal reference axis that is generally parallel to the horizon, a vertical reference axis that is perpendicular to the horizontal axis and is generally aligned with the direction of the force of gravity, or a reference axis having another orientation.

A typical level tool generally includes an elongated body that defines at least one external working surface and one or more vial openings with bubble vials secured therein. The vials may be aligned in different directions relative to the working surface for indicating the orientation of a workpiece. For example, a plumb vial may be aligned in a direction perpendicular to the working surface, and a level vial may be aligned in a direction parallel to the working surface. As a result, when the working surface engages a generally vertical workpiece, an air bubble is generally centered within the plumb vial. Similarly, when the working surface engages a generally horizontal workpiece, an air bubble is generally centered within the level vial.

Some currently known level tools have a composite metal and plastic body, including, for example, a metal frame and a pair of plastic cover plates arranged on opposite sides of the frame. The metal frame typically has a generally I-shaped cross-sectional shape, including a pair of opposing working surfaces interconnected by a web. One or more holes are formed in the web along with diametrically spaced notches formed at the sides of each hole for receiving the ends of a vial. The cover plates, which have openings that overlie the vial openings, attach to each other and/or the frame and secure the vials in place. Further, it is known that different cover plates may be molded in different colors to make the level more visually appealing. However, although the selected color may enhance the level's overall appearance, it may also reduce the visibility of the liquid and the air bubble within a vial.

Another conventional composite metal and plastic level body includes a metal frame having a generally T-shaped cross-sectional shape, including a lower wall and a perpendicular web. The web has vial receiving openings vial receiving notches formed around the openings. The body also includes a plastic upper wall having a pair of spaced-apart support sections extending downwardly therefrom. The support sections are arranged on opposite sides of the web so as to attach the upper wall to the frame. The support sections have opposed vial side-viewing windows that overlie the vial receiving openings of the web for receiving and/or retaining the vials. In addition, a cover plate is disposed over each support section for decorative purposes and/or to facilitate aligning the vials. It is known that the cover plates and plastic upper wall, including the support sections, may be separately molded of differing colors to provide an aesthetically pleasing contrast. However, separately molding these pieces requires additional assembly steps and increases manufacturing costs and can lead to inconsistent or varying product quality when the level tool is mass produced. Alternatively, it is known to combine the cover plates and the plastic upper wall and to mold these pieces as single members. However, the prior art does not disclose molding cover plates and plastic upper wall members of different colors as single members.

Other various assemblies for mounting the vials in the vial openings are also used, including, for example, plastic or rubber inserts, webs, plates, and rings that are configured to be securely disposed in the vial openings and to hold the vials therein. In particular, it is known in the art to provide vial mounting assemblies comprising two or more ring members or layers of contrasting colors or different densities, for example, so as to outline and enhance the visibility of the vials enclosed therein or to provide a desired level of impact absorption, respectively. It is also known that such ring members made of elastomeric materials having different densities may be bonded together through co-molding so that they are manufactured together in one piece. However, these vial mounting assemblies may become dislodged from the body of the level tool during use, thereby separating the vials from the body. Furthermore, these vial mounting assemblies may add to manufacturing costs and/or increase the complexity of manufacturing the level tool.

It is therefore desirable to provide an improved level tool using a plastic construction that provides an aesthetically-pleasing appearance and enhances the visibility of the vials.

### BRIEF SUMMARY

In one aspect of the present invention, there is provided a method of manufacturing a level tool comprising the steps of providing a frame, providing a pair of plastic cover plates arranged on opposite sides of the frame, and forming at least one vial window in each cover plate by a dual plastic injection molding process. The at least one vial window is made of a plastic material of a different color than the cover plate and is configured to receive and support at least a portion of a vial.

Further objects, features, and advantages of the present invention will become apparent from consideration of the following description and the appended claims when taken in connection with the accompanying drawings.

### BRIEF DESCRIPTION OF THE DRAWINGS

FIG. 1 is a top front perspective view showing a level embodying the principles of the present invention;

FIG. 2 is a front elevation view of the level;

FIG. 3 is a sectional top plan view of the level;

FIG. 4 is an end view of the level;

FIG. 5 is a sectional end view of the level taken along the line A-A;

FIG. 6 is a front elevation view of a frame of the level;

FIG. 7 is a top plan view of the frame;

FIG. 8 is an end view of the frame;

FIG. 9 is a front elevation view of a first cover plate of the level;

FIG. 10 is a top plan view of the first cover plate;

FIG. 11 is a rear elevation view of the first cover plate;

FIG. 12 is a sectional end view of the first cover plate taken along the line A-A;

FIG. 13 is another sectional an end view of the first cover plate taken along the line B-B;

FIG. 14 is a front elevation view of a second cover plate of the level;

FIG. 15 is a top plan view of the second cover plate;

FIG. 16 is a rear elevation view of the second cover plate;

FIG. 17 is a sectional end view of the second cover plate taken along the line A-A;

FIG. 18 is another sectional an end view of the second cover plate taken along the line B-B;

FIG. 19 is a front elevation view of an end cap of the level;

FIG. 20 is a front end view of the end cap;

FIG. 21 is a rear end view of the end cap; and

FIG. 22 is a top plan view of the end cap.

### DETAILED DESCRIPTION

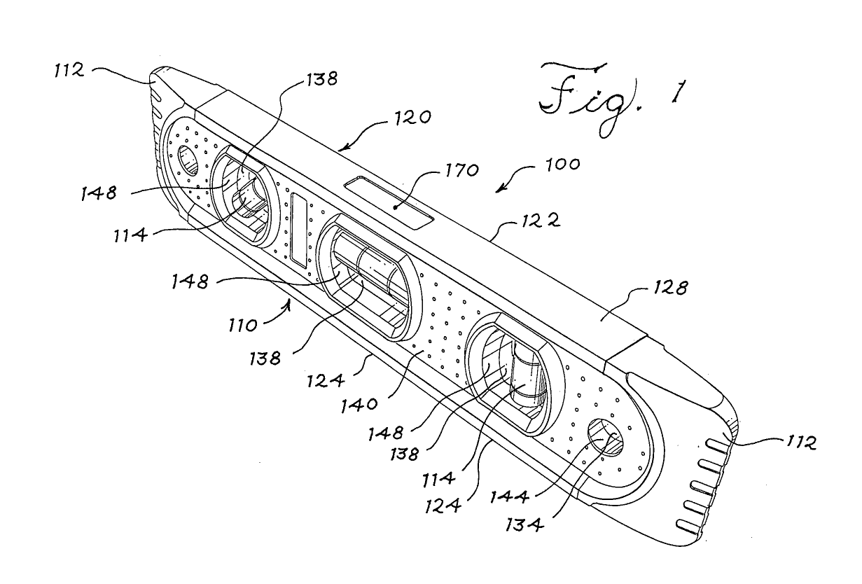

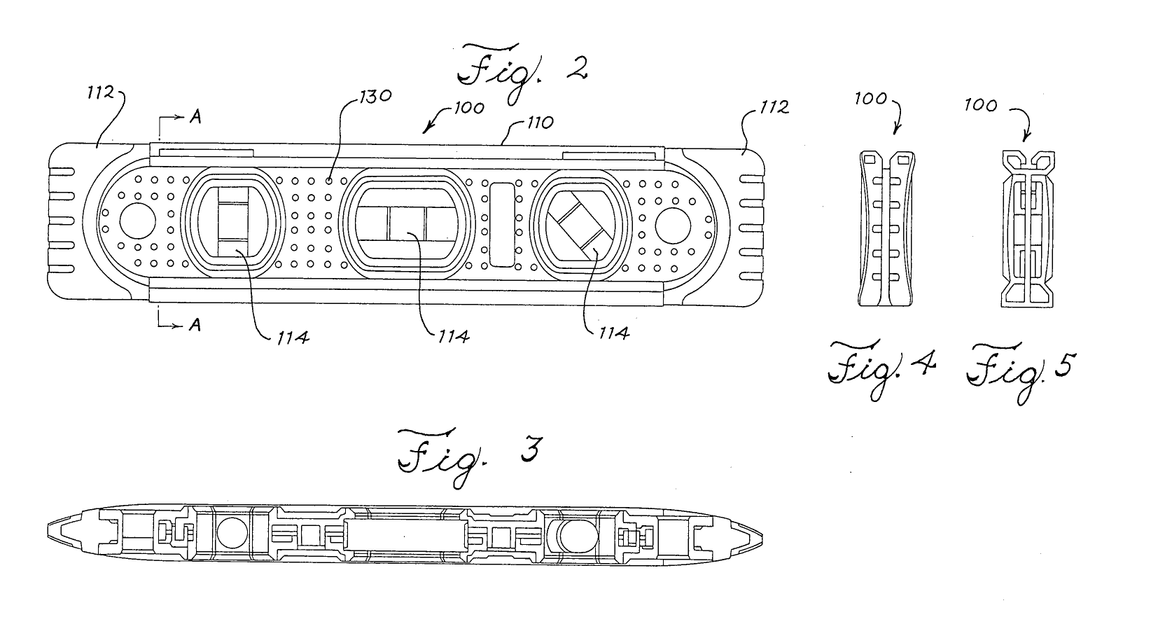

Referring now to FIGS. 1-5, there is shown one embodiment of a level tool in accordance with the principles of the present invention. In FIG. 1, the level tool 100 has an elongated body 110, a pair of end caps 112 connected to opposing ends of the body 110, and a plurality of vials 114 disposed within the body 110 at spaced apart locations along the length thereof.

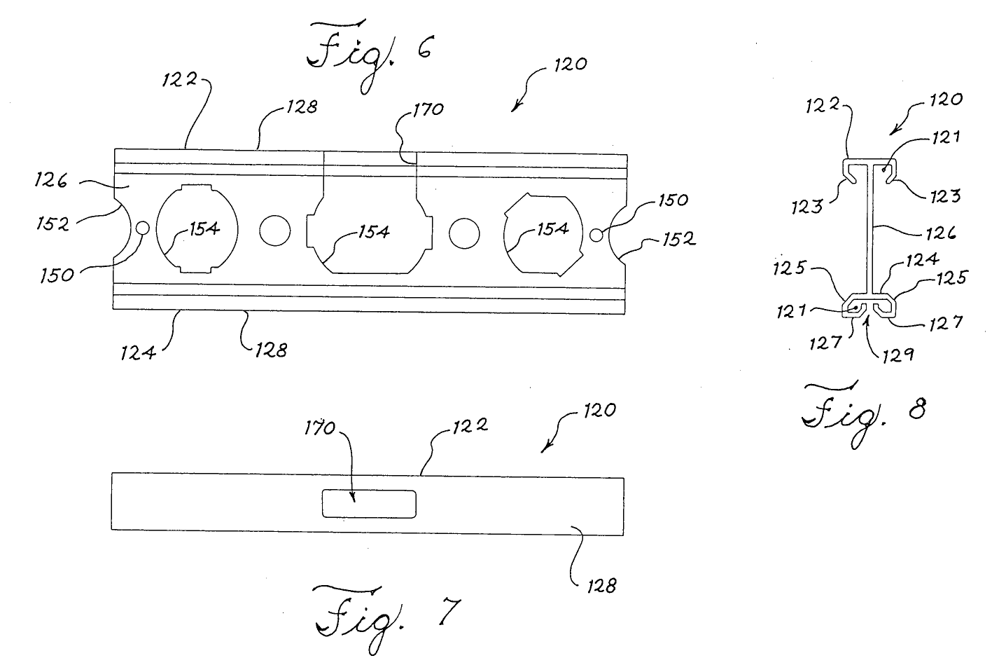

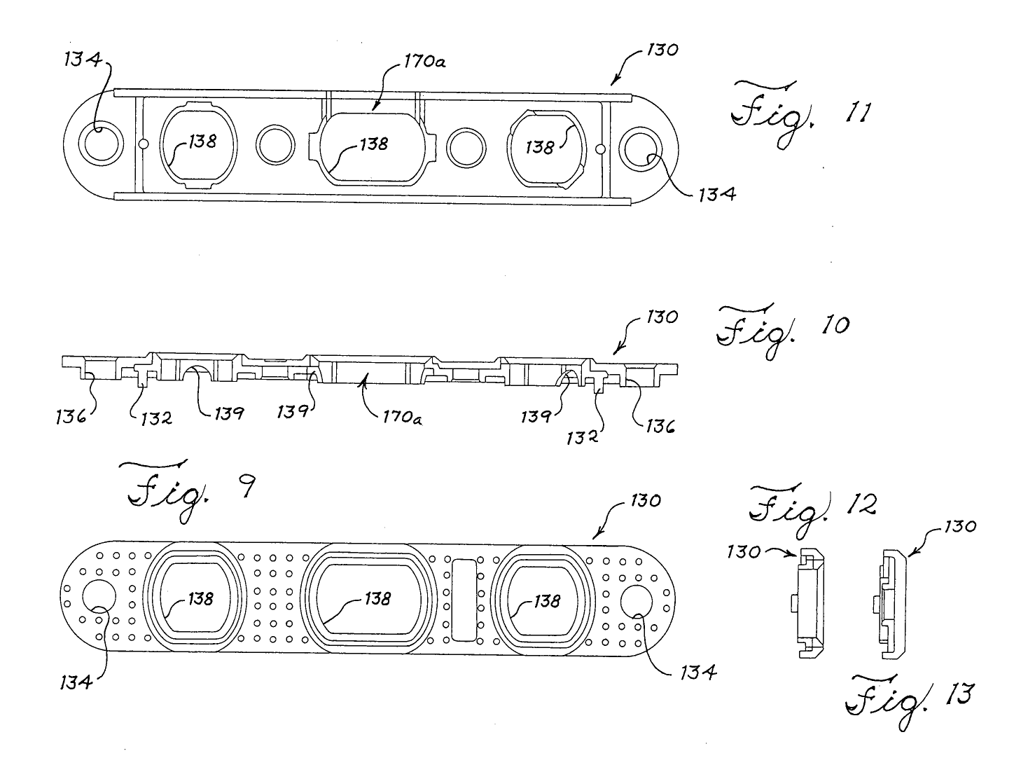

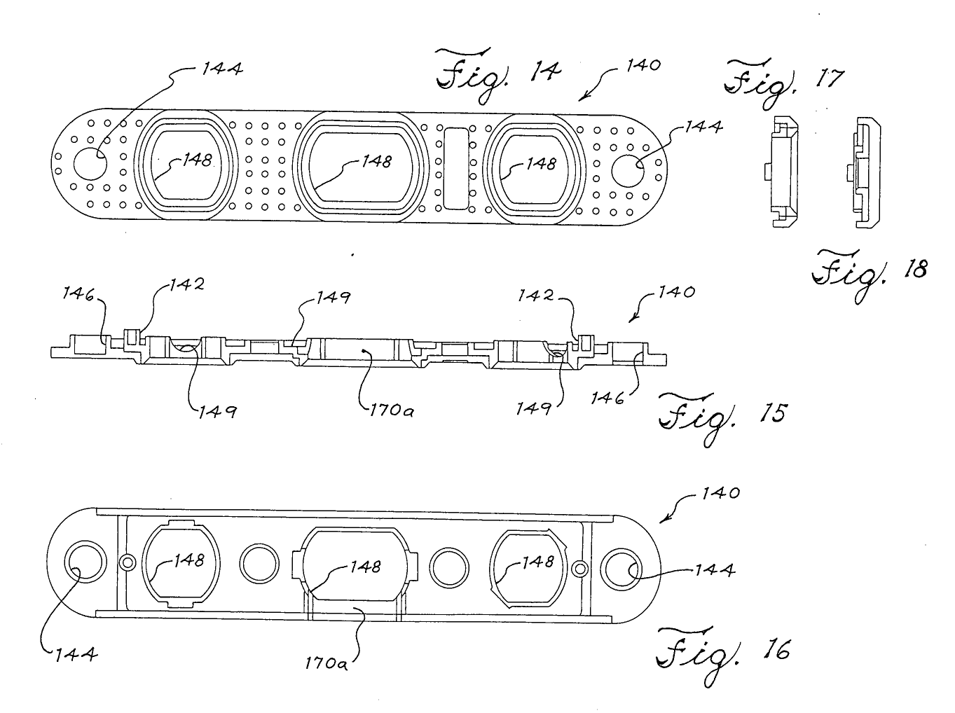

The body 110 includes a frame 120 (shown in FIGS. 6-8) and a pair of cover plates 130, 140 (shown in FIGS. 9-18) arranged on opposite sides of the frame 120. The frame 120 may have a generally solid I-shaped cross-sectional shape, as shown in FIGS. 6-8. However, it will be understood that the frame 120 alternatively may be a generally hollow member and that the cross-sectional profile of the frame can have any other suitable shape, for example, a generally rectangular cross-sectional shape. The frame 120 preferably is made of an aluminum alloy, but any other suitable material may be used, such as other metal alloys, plastic or composite materials. The frame 120 may be formed separately from the cover plates 130, 140 by an extrusion process, casting process, machining process, or any other suitable process. Alternatively, the frame 120 and the cover plates 130, 140 may be integrally molded as a one-piece member.

In particular, the I-shaped frame 120 includes a pair of top and bottom walls 122, 124 and a side wall or web 126 extending perpendicularly between the top and bottom walls 122, 124, as shown in FIGS. 6 and 8. The web 126 is a generally solid member, except for openings, slots, passageways, and indentations formed or machined into or from the web, as described in greater detail below. The top and bottom walls 122, 124 define, respectively, an upper pair of opposing, inwardly turned flanges 123 and a lower pair of opposing, outwardly turned flanges 125 that extend substantially completely along the longitudinal length of the frame 120. If desired, distance marking indicia can also be formed along the lower pair of opposing flanges 125, for example, in metric and English units, and with numerals to indicate the distance away from a starting indicia on each of the flanges 125.

The frame 120 also may include one or more parallel working surfaces 128 that are configured to contact a workpiece in a generally flush engagement for leveling the workpiece. In the present embodiment, at least a portion of one working surface 128 is defined by the outer surface of the top wall 122 that is parallel to the longitudinal axis of the frame 120. Further, the flanges 125 along the bottom wall 124 have a pair of inwardly directed projections 127 that are parallel with the bottom wall 124 such that the outermost surface of the projections can define a portion of another working surface 128. In addition, the projections 127 may define a V-shaped groove 129 that extends along the longitudinal length of the bottom wall 124 to facilitate placement against a pipe or a conduit if desired.

The cover plates 130, 140 are arranged on opposite faces of the web 126, and may have various mating features which cooperate with different openings, slots, passageways, and indentations formed or machined into or from the web 126 to facilitate assembly of the level tool. For example, as shown in FIGS. 9-18, the cover plates 130, 140 may attach to each other using a snap-fit arrangement, including a pair of pegs 132 formed on the first cover plate 130 which are snugly received by a pair of opposed receiving bosses 142 formed on the second cover plate 140. The pegs 132 engage the receiving bosses 142 through a pair of mounting holes 150 formed in the web 126 along its longitudinal axis. Using this arrangement, the cover plates 130, 140 can be secured and aligned to each other and also the frame 120. It will be understood that the cover plates 130, 140 alternatively or additionally may be attached to each other and/or the frame 120 using an adhesive or other suitable attaching means.

Each cover plate 130, 140 may also include a pair of hang holes 134, 144 at opposite ends thereof. The hang holes 134, 144 are formed in the first and second cover plates 130, 140 directly opposed to each other. In this way, inwardly extending circular walls 136 formed around the perimeter of the hang holes 134 on the first cover plate 130 and can be axially aligned with the inwardly extending circular walls 146 formed around the perimeter of the hang holes 144 on the second cover plate 140. When the cover plates 130, 140 are assembled together, each pair of opposed hang holes 134, 144 forms a hang opening that extends completely through the body 110 for hanging the level tool 100. In addition, the circular walls 136, 146 formed around the perimeter of each hang hole can help to secure the end caps 112 to the body 110, as described greater detail below.

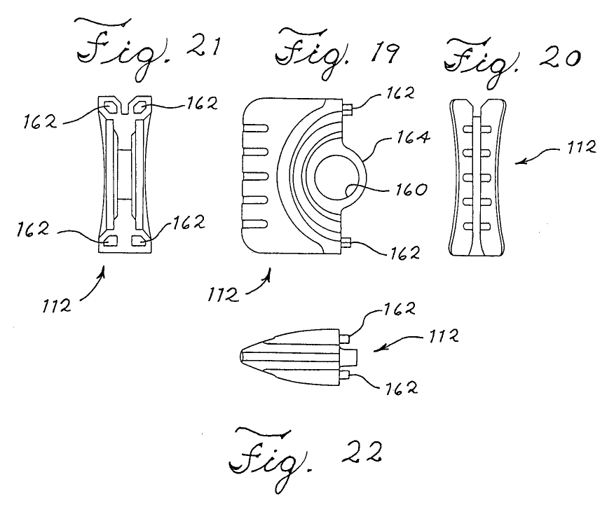

The end caps 112 shown in FIGS. 19-22 preferably are made of rubber or an elastomeric material, but other suitable materials may be used, such as plastic. Each end cap 112 may have a centering hole 160 formed in an end portion of the end cap and a plurality of tab members 162 that extend longitudinally therefrom. The end portion of an end cap 112 is received between opposed ends of the first and second cover plates 130, 140 such that each centering hole 160 is aligned with the opposed hang holes 134, 144 of the first and second cover plates. Each centering hole 160 is dimensioned so as to closely receive the circular walls 136, 146 formed around the perimeter of the opposed hang holes 134, 144, thereby securing the end caps 112 to the cover plates 130, 140. Further, the outer surfaces of the centering hole 160 may define semi-circular projections 164, which mate with the semi-circular slots 152 formed at opposite ends of the web 126.

The tab members 162 are configured to be received within corner recesses 121 of the frame 120, which are defined by the web 126, the top and bottom walls 122, 124 and the upper and lower pair of opposing flanges 123, 125. In this way, the end caps 112 engage both the frame 120 and the cover plates 130, 140 so as to be securely held in place when these pieces are assembled.

Referring again to FIGS. 9-18, integrally molded, spaced-apart vial windows 138, 148 formed in the first and second cover plates 130, 140 are aligned with each other so that the cover plates 130, 140 define pairs of opposed vial windows 138, 148. Each pair of opposed vial windows 138, 148 is configured to receive and support a vial 114 in the plane of the web 126 for indicating the orientation of a workpiece with respect to a reference axis. In the present embodiment, for example, the level tool 100 includes three vials 114 positioned so as indicate the orientation of a workpiece with respect to a horizontal axis, a vertical axis, and an axis that is oriented forty-five (45) degrees relative to the horizontal axis when one of the working surfaces engages the workpiece.

In particular, each pair of opposed vial windows 138, 148 overlays a corresponding vial opening 154 formed in the web 126 of the frame 120. The vial openings 154 may be shaped such that the outline of each vial opening 154 is generally similar to the shape of the opposed vial windows 138, 148 received therein. When the cover plates 130, 140, the vials 114, and the frame 120 are assembled, the pairs of opposed vial windows 138, 148 form openings that extend completely through the body 110 to allow a user to view the vials 114 from either side, as shown in FIGS. 1-3.

Each pair of opposed vial windows 138, 148 is configured to hold a vial 114 therebetween. For example, a first pair of opposing recesses 139 disposed around each vial window 138 on the interior surface of the first cover plate 130 mate with a second pair of recesses 149 disposed around each vial window 139 on the interior surface of the second cover plate 140. The recesses 139, 149 may be shaped and dimensioned so as to closely receive and support the ends of a vial 114 therebetween in the plane of the web 126 when the frame 120 and cover plates 130, 140 are assembled.

In addition, a viewing aperture 170 is formed in the top wall 122 above the center vial opening 154. The viewing aperture 170 is aligned with apertures 170a formed in the cover plates 130, 140 above the center vial windows 138, 148. In this way, when the working surface 128 defined by the outer surface of the bottom wall 124 engages a workpiece, a user can view the center vial 114 mounted in the center vial windows 138, 148 through the viewing aperture 170.

In accordance with the present invention, the cover plates 130, 140 are made using a dual plastic injection molding process. As used herein, the term dual plastic injection molding process refers to one or more techniques for producing injection molded parts from two different thermoplastic materials, including insert molding, two-shot molding and co-injection molding. As a result, the cover plates 130, 140 and the vial windows 138, 148 may be integrally molded using thermoplastic materials of different or contrasting colors. For example, a cover plate 130, 140 may be molded primarily in a color which is selected so as to improve the aesthetics of the level tool 100 or to correspond to the manufacturer's trade dress, while the vial windows 138, 148 are molded in a contrasting and/or lighter color so as to outline and/or enhance the visibility of the vials 114. Also, a cover plate 130, 140 and the vial windows 138, 148 may be integrally molded using thermoplastic materials of different densities.

The dual plastic injection molding process may utilize, for example, a mold having a first cavity corresponding to the shape of a cover plate 130, 140 without the vial windows 138, 148 and a second cavity corresponding to the shape of the vial windows 138, 148. The molding can be done using simultaneous or sequential shots of molten plastic materials of differing colors into the two cavities. In particular, the mold has a main cavity in the shape of a cover plate and tooling is provided for blocking off different areas of the mold cavity, including the areas corresponding to the vial windows. During the injection molding process, the tooling is first configured to block off the areas for the vial windows and a first molten plastic material having a first color is injected into the mold cavity so as to partially form the cover plate. After the first material is injected, the tooling is reconfigured to block off the cavity except for the areas corresponding to the vial windows. Then, a second molten plastic material having a second contrasting color is injected to form the vial windows. As the first and second materials come into contact and cool, they solidify into a cover plate 130, 140 having vials windows 138, 148 of different color that are integrally bonded thereto.

While the present invention has been described in terms of preferred embodiments, it will be understood, of course, that the invention is not limited thereto since modifications may be made to those skilled in the art, particularly in light of the foregoing teachings.

What is claimed is:

1. A method of manufacturing a level tool, the method comprising:
providing a frame;
providing a pair of plastic cover plates arranged on opposite sides of the frame; and
forming at least one vial window in each cover plate by a dual plastic injection molding process, wherein the at least one vial window is made of a plastic material of a different color than the cover plate and is configured to receive and support at least a portion of a vial.

2. The method of claim 1, wherein the dual plastic injection molding process is selected from the group consisting of an insert molding process, a two-shot molding process and co-injection molding process.

3. The method of claim 1 wherein the at least one vial window is integrally molded with the cover plate by a two-shot molding process using a mold having a first cavity corresponding to a shape of the cover plate without the at least one vial window and a second cavity corresponding to a shape of the at least one vial window.

4. The method of claim 3 wherein the cover plate is formed by injection of a shot of molten plastic material of a first color into the first cavity and a shot of molten plastic material of a second color into the second cavity, wherein the molten plastic material of the first color and the molten plastic material of the second color come into contact and solidify to form the cover plate.

5. The method of claim 1 wherein the different color of the plastic material of the at least one vial window enhances a visibility of the at least one vial.

6. The method of claim 1 wherein the different color of the plastic material of the at least one vial window is a lighter color than the cover plate.

7. The method of claim 1 wherein the frame and the cover plate are integrally molded by a dual plastic injection molding process as a one-piece member.

8. The method of claim 1 wherein the plastic material of the at least one vial window has a different density than the cover plate.

9. The method of claim 1 wherein a first cover plate of the pair of cover plates comprises a peg and a second cover plate of the pair of cover plates comprises a receiving boss; and
wherein the peg is configured to connect with the receiving boss through a hole in the frame to secure and align the pair of cover plates with the frame.

10. The method of claim 1 wherein the pair of cover plates define a pair of hang holes spaced opposite each other that cooperate to form a hang opening that extends completely through the frame.
